(19) United States
(12) Patent Application Publication
(10) Pub. No.: US 2008/0249705 A1
(43) Pub. Date: Oct. 9, 2008

(54) Realtime delivery system for updated map data

(76) Inventor: Hitoki Matsuda, Torrance, CA (US)

Correspondence Address: MURAMATSU & ASSOCIATES, Suite 310, 114 Pacifica, Irvine, CA, 92618, US

(21) Appl. No.: 11/732,563

(22) Filed: Apr. 4, 2007

(51) Int. Cl. G01C 21/32

(52) U.S. Cl. 701/208

(57) ABSTRACT

A realtime map data delivery system delivers the updated map data to navigation systems in an XML format through various communication means. The realtime map data delivery system includes a map data supplier server which generates, in realtime, map data in a predetermined format every time when the map data is updated, a map data delivery server which retrieves, in realtime, updated portions of map data and converts the updated map data to an extensible markup language format (updated XML map data) and stores the updated XML map data for delivery, and a navigation system which has XML format map data and accesses the map data delivery server through a communication network and downloads the updated XML map data to update the XML format map data.

### FIELD OF THE INVENTION

This invention relates generally to a map data delivery system for delivering updated map data to navigation systems, and more particularly, to a realtime map data delivery system for delivering the updated map data to navigation systems in an XML format through various communication means.

### BACKGROUND OF THE INVENTION

A navigation system performs travel guidance for enabling a user to easily and quickly reach the selected destination. Such a navigation system detects the position of the user's vehicle, and reads out map data pertaining to an area at the current vehicle position from a data storage medium. Typically, the navigation system displays a map image on a monitor screen while superimposing thereon a mark representing the current location of the user. At an intersection, the navigation system notifies the user which direction to turn for reaching the destination.

In creating the map data for a navigation system, geographic data available in the market is used as the original data. For example, such geographic data is in a GDF (geographic data file) format which is a standardized format for geographic (map) data that is typically provided by a map data supplier. The GDF format defines the data structure (physical record structure) which includes “Field Name”, “Size”, “Type”, “Description”, etc. in a predetermined order.

Since the GDF is a map data file which simply describes the topological structures, it is not always well suited for a navigation system of a particular manufacturer. Thus, a manufacturer usually converts the GDF format data into a data format that is more suitable for the hardware and software of a proprietary navigation system, for example, PSF (physical storage format). The PSF is a format that takes the limitations of the hardware performance of the navigation system into consideration to make the map data suitable for the navigation system.

FIG. 1 is a schematic diagram showing an example as to how the original GDF map data is constructed into meshed data in the PSF file. In this method, a map area 23 is a graphical representation of a selected area such as a county, a city, etc., that is generated by the original map data provided by a map data supplier. In the PSF file, the map area 23 is divided into a plurality of meshed portions (cells) 21 each having a rectangular shape of a predetermined size. Each meshed portion 21 includes geographical data for displaying a map image on a navigation system.

During the process of converting the GDF map data to the PSF map data, in order to accommodate several different map scales for enlarging or shrinking the map image on the display screen, data with a plurality of different sizes need to be produced based on the GDF map data. This requires additional processes of data conversion and calculation, which increases the conversion time and labor. Further, because the map area is divided into a plurality of meshed portions 21, complicated processing is necessary for matching the among the meshed portions 21. Moreover, because the format of the PSF map data is fundamentally different from that of the GDF map data, the process to convert the GDF map data into the PSF map data is extremely complex and time consuming. For example, in the case where the map data overs a large area such as the whole north America, the process for conversion can take several weeks.

Other disadvantage associated with the PSF map data is its inflexibility and lack of expandability. It is often necessary to update the map data for a navigation system because new roads and new buildings are built frequently. The process of adding the new data or modifying the existing data in the PSF data file generally requires regeneration of the entire map data. In addition, because the PSF data is machine dependent, recompilation of the data would be necessary if different hardware or software is to be used or an existing navigation system is changed or modified.

In updating the map data for the navigation system, typical method involves the step of obtaining the updated map data (the difference of the newly available data and the data that has been accumulated in the past) from the map data supplier. Then, the step of converting the updated map data into the format used in the navigation system will follow. Finally, the step of delivering the updated map data to the navigation systems is conducted.

As noted above, conversion of the map data between the GDF format and the PSF format requires a large amount of computer resources and conversion time. Thus, even though the map data is updated frequently by the map data supplier, the updating of the map data for navigation systems has not been frequently conducted in the industry today. For example, the map data for navigation systems has been updated, for example, only once a year, or at the most four times a year (quarterly).

FIG. 2 is a schematic diagram showing an example of a conventional configuration of delivery system for updated map data. A map supplier server 51 releases updated map data frequently such as every day as indicated by updated map data 61. Even through the map data is updated frequently, because of the long conversion time, the updated map data is simply accumulated for a long period of time. Then, a manufacturer of navigation systems converts the entire map data 62 including the accumulated update to the format such as PSF for the navigation system to create a map data disc 81. The map data in the disc 81 is compared with the map data in the previous map data disc 82. The difference between the two is stored in a storage medium 85 as the updated map data and physically delivered through a delivery server 52 to the user of navigation system 91.

As noted above, in the conventional technology, it is not feasible to quickly deliver the updated map data to the users of navigation system. Further, since it is unknown to the manufacturer of the navigation system as to which version of the updated map data is installed in a particular navigation system, the manufacturer has to prepare an enormous amount of different combination of the updated map data files. Therefore, it is desired that the map data be updated more frequently and more easily to provide accurate route guidance. Further, there is a need of delivering the updated map data to the navigation systems through various communication means rather than the physical delivery.

### SUMMARY OF THE INVENTION

It is, therefore, an object of the present invention to provide a map data delivery system for navigation systems which is able to distribute the updated map data more frequently and easily.

It is another object of the present invention to provide a map data delivery system for navigation systems which is capable of delivering the updated map data through communication means by utilizing XML/SVG format map data converted from geographic data.

The realtime map data delivery system delivers the updated map data to navigation systems in an XML format through various communication means. The realtime map data delivery system includes a map data supplier server which generates, in realtime, map data in a predetermined format every time when the map data is updated, a map data delivery server which retrieves, in realtime, updated portions of map data and converts the updated map data to an extensible markup language format (updated XML map data) and stores the updated XML map data for delivery, and a navigation system which has XML format map data and accesses the map data delivery server through a communication network and downloads the updated XML map data to update the XML format map data.

According to the present invention, the map data delivery system is able to update the map data for a navigation system in realtime and deliver the updated map data to the user at any desired time. The map data is in the XML format so that the map data can be easily modified, combined with other map data, and transmitted through the communication network. Thus, the present invention allows frequent renewal of the map data for navigation systems with use of a simple configuration without requiring a high level processor or a long conversion time. Further, since each update data includes past update data, the complete data necessary for the update can be downloaded from the map data delivery server through one operation. Accordingly, it is unnecessary for the map data delivery server or manufacturer of the navigation system to prepare an enormous amount of combinations of the updated map data.

### BRIEF DESCRIPTION OF THE DRAWINGS

FIG. 1 is a schematic diagram showing a conventional method of utilizing the map data for a navigation system by dividing a selected area into a plurality of rectangular areas or cells.

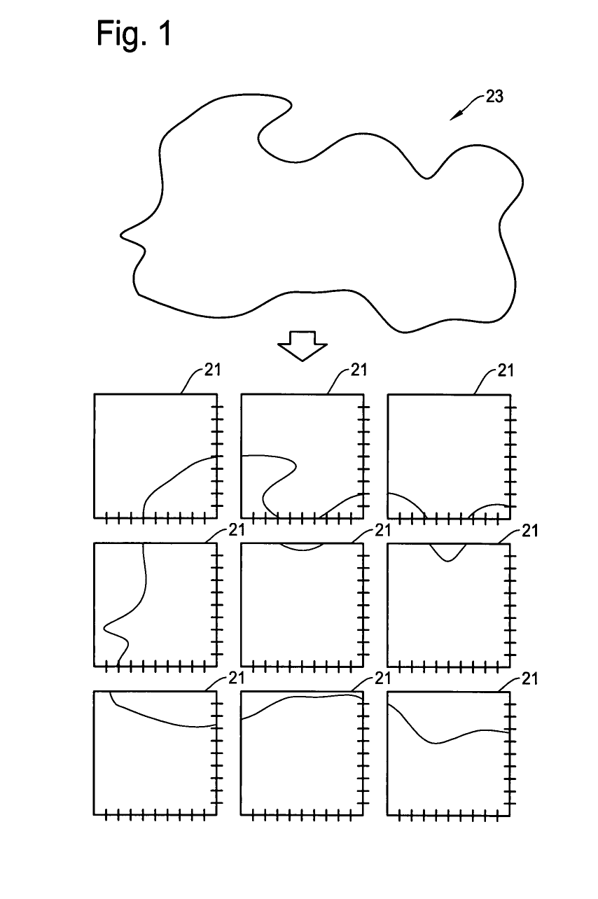

FIG. 2 is a schematic diagram showing an example of a conventional configuration of updated map data distribution system for navigation systems.

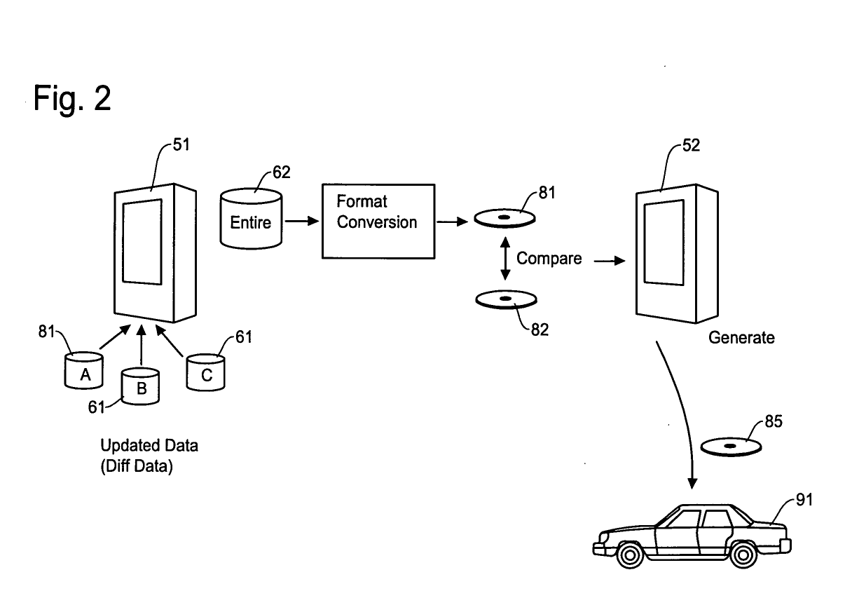

FIG. 3 is an example of description of the XML text data that describes the map data on the basis of administrative area incorporated in the map data delivery method and system of the present invention.

FIG. 4 is a schematic diagram showing an example of a system configuration of updated map data distribution for navigation systems under the present invention.

FIG. 5 is a flow chart showing the basic operational steps for updating the map data in an embodiment under the present invention.

FIG. 6 is a flow chart showing the sub-process of the step 103 in FIG. 5 for generating the updated XML format map data for a navigation system under the present invention.

FIG. 7 is a flow chart showing the sub-process of the step 105 in FIG. 5 for using a user profile to generate customized updated XML map data for a navigation system under the present invention.

FIG. 8 is a flow chart showing the sub-process of the step 106 in FIG. 5 for executing an XML script of the updated XML map data to install the map data in a navigation system under the present invention.

FIG. 9 is a block diagram showing an example of configuration of a vehicle navigation system for implementing the present invention utilizing the XML format map data.

FIG. 10 shows an example of description of a map log produced by a map data supplier when the map data is updated where the map log is in the XML format.

FIG. 11 shows an example of structure of the XML format map data indicating a particular road link which is used in the navigation system and the map data delivery system of the present invention.

FIG. 12 shows an example of description of the XML format map data derived from the map log of FIG. 10 indicating the update related to a particular road link, which will be produced by the map data delivery server 53 of FIG. 4.

FIG. 13 is shows example of description of the XML format map data almost identical to that of FIG. 12 except that it is described in a manner to show the update operation of the navigation system.

FIG. 14 shows another example of description of the XML format map data derived from a map log from the map data supplier indicating the update to replace a particular line with another line.

### DETAILED DESCRIPTION OF THE PREFERRED EMBODIMENT

The present invention will be described in detail with reference to the accompanying drawings. The map data delivery system under the present invention is able to update the map data for a navigation system in realtime and deliver the updated map data to the user at any desired time. The present invention allows frequent renewal of the map data for navigation systems with use of a simple configuration without requiring a high level processor or a long conversion time. Further, since each update data includes past update data, the complete data necessary for the update can be downloaded from the map data delivery server through one operation. Accordingly, it is unnecessary for the map data delivery server prepare a large amount of different combinations of the updated map data.

The map data delivery system of the present invention utilizes map data in an extensible markup language (XML) and scalable vector graphics (SVG) format converted from geographic data such as GDF (geographic data file). The assignee of the present application has proposed a navigation system that uses XML/SVG data for representing map data to solve the disadvantages associated with the conventional technology, the details of which are disclosed by U.S. patent application Ser. No. 11/348,821. The updated map data in the XML/SVG formats will be efficiently distributed through communication networks.

It should be noted that the specific names, XML and SVG, are used in the present invention for describing the languages or formats of the map data only for an illustration purpose. Thus, the scope of the present invention should not be limited to such particular names but should encompass any language and format equivalent to that of XML and SVG in terms of function and effect. SVG is a type of mark-up language for describing graphic images using XML syntax. In other words, SVG is a mark-up language designed after XML syntax to create vector graphics for display on computer systems. In the description of the present invention, hereafter, the word “XML” is used as a term inclusive of XML, SVG and other mark-up languages.

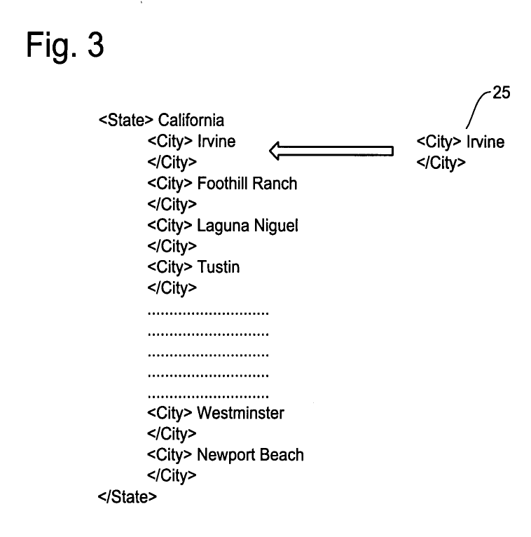

FIGS. 3 shows an example of description in the XML text data that describes the map data on the basis of administrative area. This example shows a case which lists cities in the state of California by the XML text data, where the city categories are included in the state category. Thus, for example, in the city of “Irvine”, many geographical elements are nested such that their relationships with one another are clarified. Data for such elements as the road, POI, etc., are further included in each city category although they are omitted in FIG. 3 to simplify the feature of the XML format map data.

By nesting the data into the jurisdiction (administration region) basis, several advantages can be obtained. The user can easily search particular point of interest (POI) within a city because the navigation system utilizing the layered XML map data described above. Moreover, when a city or a state changes its traffic regulation, constructs new building, etc., updating the data to reflect this change is easily done due to the nested structure of the XML format map data.

The XML map data is advantageous in its capability of easily displaying the contents on a monitor screen or modifying the contents. For instance, when the map data for the city of Irvine is to be replaced with a new map data 25 for Irvine, the data can be easily modified by replacing the old tag by the new one. Likewise, the XML format allows to easily modify certain portions of the map data such as points of interest, road link, etc.

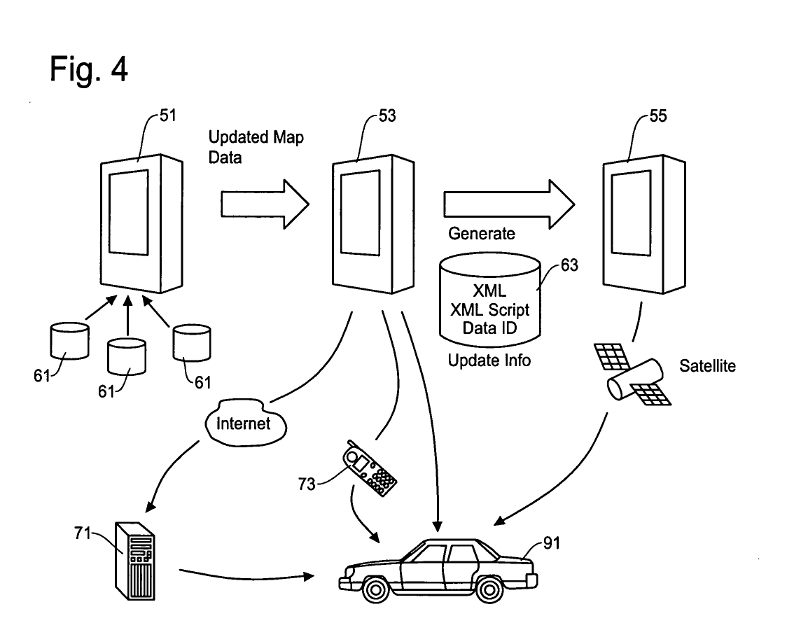

The basic configuration of the realtime map data delivery system under the present invention is described with reference to the schematic view of FIG. 4. The basic configuration of FIG. 4 includes database servers, communication networks, and navigation systems. In this embodiment, the navigation system is implemented in a vehicle (vehicle navigation system), but the navigation system under the present invention may also be implemented to other devices such as a portable device, a cellar phone, laptop computer, etc.

This configuration mainly comprises a map data supplier server 51, a map data delivery server 53, and a map data broadcasting server 55, and navigation systems 91. The map data supplier server 51 stores map data and constantly updates the map data to keep the database up-to-date. As new roads, buildings, POIs (points of interest) are constructed, the map data supplier server 51 produces, in realtime, updated map data as represent by updated map data 61.

The map data delivery server 53 is typically maintained by a manufacturer of navigation systems. The map data delivery server 53 checks the updates of the map data in the map data supplier server 51 and retrieves, in realtime, the updated map data from the map data supplier server 51 if it determines that updated map data is available. In the case where the updated map data is embedded in the overall map data, the map data delivery server 53 detects the difference from the previous overall map data to retrieve only the updated portions of the map data. Thus, the updated map data detected can be a small unit of POI, road link, etc.

The map data delivery server 53 converts the retrieved updated map data into a map data of an XML format that allows to update map data in a navigation system 91 efficiently as will be described later in detail. The process of generating the XML format map data from the map data provided from the supplier is described in the above noted U.S. patent application Ser. No. 11/348,821. The generation of the updated XML format map data may be conducted in realtime or any desired time. Alternatively, it may be arranged in such a way that a map data supplier produces the XML format map data every time when the map data is updated so that the updated XML format map data will be sent from the map data supplier server 51 to the map data delivery server 53.

The updated XML map data file 63 is comprised of XML representation of the updated map data, an XML script for a batch processing to update map data in the navigation system 91, and an update data ID that indicates an identity of the updated XML map data. Further, update information is attached to the updated XML map data file 63 so that a user can understand an area name, road name, contents of update, etc., when the user accesses the map data delivery server 53. The updated XML map data can be a small unit of POI or load link to a large unit of whole city, county, etc., i.e., any difference from the previous map data. The update data ID is assigned to such a unit of updated XML map data based on, for example, the type of map data.

The map data delivery server 53 can deliver the updated XML map data as soon as the updated XML map data is ready or after accumulating the updated XML map data for a predetermined time period. When delivering the updated XML map data, the map data delivery server 53 also sends, in addition to the update data ID and XML script, the update information showing the area name, road name, contents of the update, etc. to the user. Preferably, not only the update information of the current update but also past update information and update history covering a predetermined past time length are also delivered to the user.

The updated XML map data can be distributed through various distribution channels. For example, without involving the data broadcasting server 55, the realtime map data delivery system may send the updated XML map data directly to a cellar phone 73 from the map data delivery server 53. The updated XML map data stored in the cellar phone 73 can be used by the cellar phone by itself if it has a navigation function or may be sent to the navigation system 91 through, for example, Bluetooth.

Further, it is also possible to distribute the updated XML map data via internet to a user's personal computer 71. As the user downloads the updated XML map data into a computer 71, the user may update the navigation system 91 by using a storage medium such as a memory card, compact disc, etc., to install the updated XML map data to the navigation system 91. Alternatively, the updated XML map data may be transmitted from the computer 71 to the navigation system 91 via a wireless transmission means such as Bluetooth.

Moreover, the updated XML map data can be sent to the data broadcasting server 55 which distributes the updated map data via, for example, a satellite communication such as satellite radio. The navigation system 91 will receive the updated XML map data and install the updated map data as will be described later in detail. In the example of FIG. 4, the realtime map delivery system is configured by the map data supplier server 51, the map data delivery server 53, and the data broadcasting server 55. However, other configurations are also feasible where a web server, a database server, etc. are incorporated.

In the XML map data file 63 shown in FIG. 4, the main content therein is the updated XML map data. As explained above, the XML data is a tag-based data format that is flexible and is easy to modify. The navigation system 91 adds the updated XML map data to the existing XML map data or replaces the old XML map data in the navigation system 91 to update the map data. As noted above, the XML map data does not involve the division of map data into rectangular units (cells), as in the conventional PSF format map data, which tends to add complexity in generating and updating map data. Thus, the update procedure in the present invention can be conducted easily and quickly.

The XML script enables to execute a series of jobs for the procedure of map data update all at once (batch processing). Typically, the XML script is designed to be executable by the navigation system 91, and thus it is mainly used for updating the updated XML map data to the navigation system 91. When downloading the updated XML map data, the navigation system 91 can automatically implement the XML script to update the map data.

In some update procedures, prior updates of the map data may be prerequisite for the renewal of the current updated XML map data. For example, this situation arises when a new building (current update) is completed on a recently developed strip of land (prior update). The XML script can be used to check whether such a prerequisite update has been installed in the navigation system 91. If the prerequisite update does not exist in the navigation system, the XML script will so notify the user. The XML script may also execute the procedure to request the map data delivery server 53 to retrieve the prerequisite update that has not been updated in the navigation system 91. For downloading the updated XML map data, the user may set a user profile to create preferred settings as will be described in detail later.

When the updated XML map data file 63 is produced, the map data delivery server 53 also generates the update data ID for the updated XML map data as noted above. The update data ID helps the navigation system 91, the map data delivery server 53, and the data broadcasting server 55 to identify the updated XML map data so that the update history and procedure can be managed by an overall system with use of the update data ID. For example, the update data ID can be used to identify which particular updated map data has been installed. The update data ID may be a number, a descriptive name, etc.

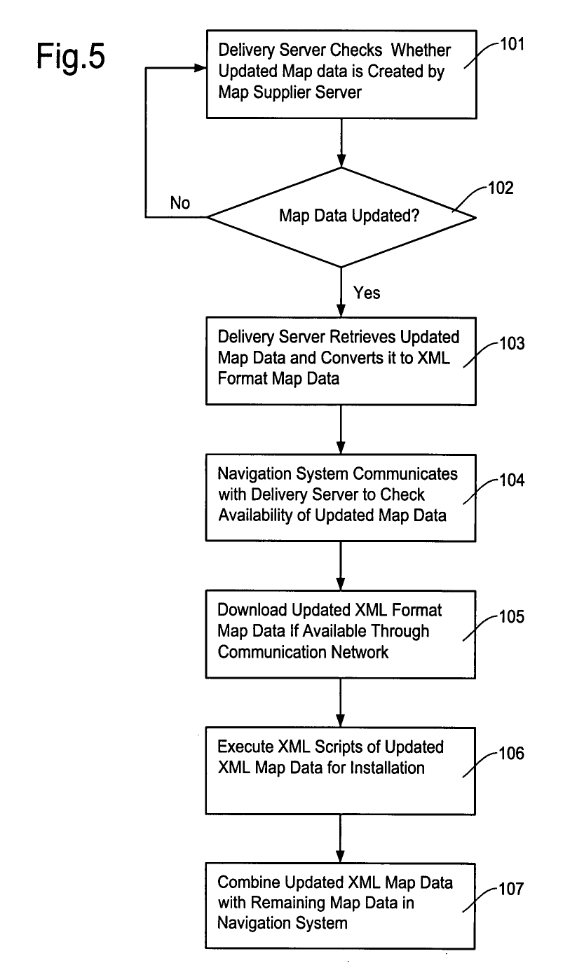

FIG. 5 is a flow chart showing the basic steps of updating the map data in an embodiment of the present invention. First, in step 101, the map data delivery server 53 communicates with the map data supplier server 51 to see whether there is newly updated map data. In step 102, the process determines whether the map data is updated and repeats the steps 101 and 102 until the map data is updated. When the map data is updated, the map data delivery server 53 retrieves the updated portion of the map data which is typical in the GDF format and converts it to XML format map data in step 103. Alternatively, as noted above, it is also feasible that a map data supplier produces the XML format map data every time when the map data is updated so that the updated XML format map data will be sent from the map data supplier server 51 to the map data delivery server 53. The map data delivery server 53 stores the updated XML map data and is ready to deliver the map data whenever there is a delivery request by a user.

In step 104, the navigation system 91 communicates with the map data delivery server 53 or the map data broadcasting server 55 and checks the availability of updated XML map data. If the newly updated XML map data exist in the map data delivery server 53 and if the user wants the updated XML map data, the navigation system 91 downloads the updated XML map data in step 105. The user can see the update data ID and the update information (area name, road name, content of update, etc.) attached to the updated XML map data so that the user can make a decision whether the update is necessary. As noted above, the user of the navigation system can download the updated map data 63 from the map data delivery server 53 or the map data broadcasting server 55 if a predetermined condition has been met.

As noted above with reference to FIG. 4, the updated XML map data file 63 includes the XML script in addition to the body of the updated map data. Thus, the navigation system 91 will execute the XML script of the updated XML map data at step 106. The XML script may check the status of the navigation system 91 to determine if other updated XML map data would be necessary to install the current updated XML map data. The XML script may also check the unique ID or key of the navigation system 91 to determine whether the navigation system 91 can legally update the renewal data.

According to the instruction of the XML script, the navigation system 91 will update the map data in the navigation system 91. Finally, in step 107, the map data of the navigation system 91 is renewed by combining the updated XML map data with the preexisting XML map data. Since the map data is in the XML format, it is easily transmitted through the communication channels and combined with other map data.

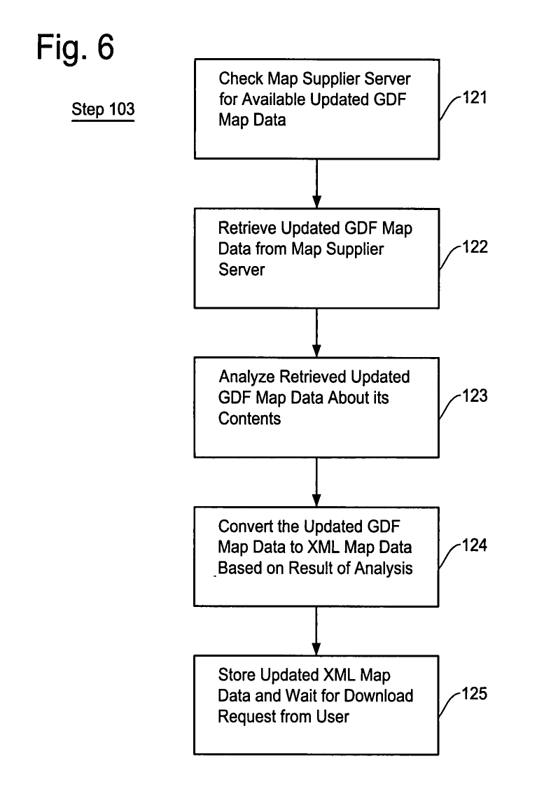

FIG. 6 is a flow chart showing the process of preparing the updated XML map data for updating the navigation system 91. In other words, the process of FIG. 6 is a sub-process of the step 103 of the flow chart of FIG. 5. As noted above, the update of the map data in the conventional technology has not been frequently conducted due to the complexity and time consuming procedures involved in updating the map data. In the present invention, however, since the navigation system uses the XML map data, the process for the transmission and renewal of the map data becomes much faster and easier, and therefore allows frequent and customized update.

In step 121, the map data delivery server 53 communicates with the map data supplier server 51 and checks the availability of the updated map data. Generally, a map data supplier constantly updates the map data based on new information such as new road, building, POI, etc., and stores the updated map data in its depository. As noted above, generally, the map data provided by the map data supplier is in a particular data format, for example, the GDF (geographic data file) format.

When the updated map data 61 is produced, the map data delivery server 53 retrieves the updated map data in step 122. For converting the GDF format map data to the XML format map data, in step 123, the map data delivery server 53 analyzes the updated GDF map data in step 123 to see each content in the updated map data. Based on the analysis, the map data delivery server 53 converts the updated GDF map data to the XML format map data in step 124. Alternatively, as noted above, it is also feasible that the map data supplier produces the XML format map data every time when the map data is updated so that the updated XML format map data will be sent from the map data supplier server 51 to the map data delivery server 53. In such a case, the process similar to that of FIG. 6 will be carried out by the map data supplier server 51. The map data delivery server 53 stores the updated XML map data to deliver it upon receiving a download request from the user in step 125.

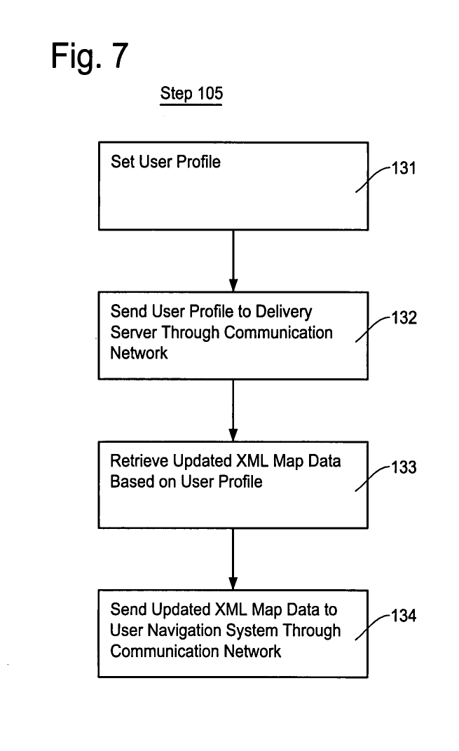

FIG. 7 is a flow chart showing the process of downloading the updated XML map data for updating the navigation system 91. In other words, the process of FIG. 7 is a sub-process of the step 105 of the flow chart of FIG. 5. For downloading the updated XML map data, as noted above, the user may set a user profile to create preferred settings. For example, the user may set a desired frequency of update or a geographic area to be updated, etc. in the user profile. The user profile set by the user can be sent to the map data delivery server 53 which generates the updated XML map data and transmits the same to the user based on the user profile.

In such a case, the downloading process of the updated XML map data is performed in the manner described in the flow chart of FIG. 7. The user will set the user profile in step 131 via a navigation system, a personal computer (PC), or other device that allows the user to input the settings. As the user profile has been set, in step 132, the navigation system 91 will send the user profile to the map data delivery server 53 through the communication network.

In a case where a user profile that has been previously set by the same user exists in the map data delivery server 53, the new user profile will replace the old user profile. Alternatively, the user profile will be saved as a new user profile while maintaining the old user profile. The map data delivery server 53 retrieves the updated XML map data based on the user profile in step 133. For instance, the map data delivery server 53 will generate the updated XML map data having only California map data in the case where the user profiles specifies that only California map data is to be updated. Finally, the map data delivery server 53 or the map data broadcasting server 55 sends the updated XML map data to the user's navigation system 91 in step 134.

Alternatively, the user profile may be saved in a PC or a navigation system without being transmitted to the map data delivery server 53. When the user connects the navigation system or PC with the map data delivery system of the present invention, the map data delivery server 53 checks the user profile in the navigation system or PC. Then, the map data delivery server 53 retrieves the updated XML map data based on the user profile. For example, even when the updated XML map data extends to an overall country, the map data delivery server 53 sends only the updated XML map data corresponding to California to the user if the user profile so specifies.

The user profile may also be created automatically without user's inputs. Since a typical navigation system records the destinations previously selected for future use, a user profile may be created based on such previous destinations. For example, the navigation system may automatically register the areas covering the previous destinations as a part of the user profile. If the updated XML map data is effective to such registered areas, the map data delivery server 53 may retrieve and send the updated XML map data regarding the registered areas to the navigation system.

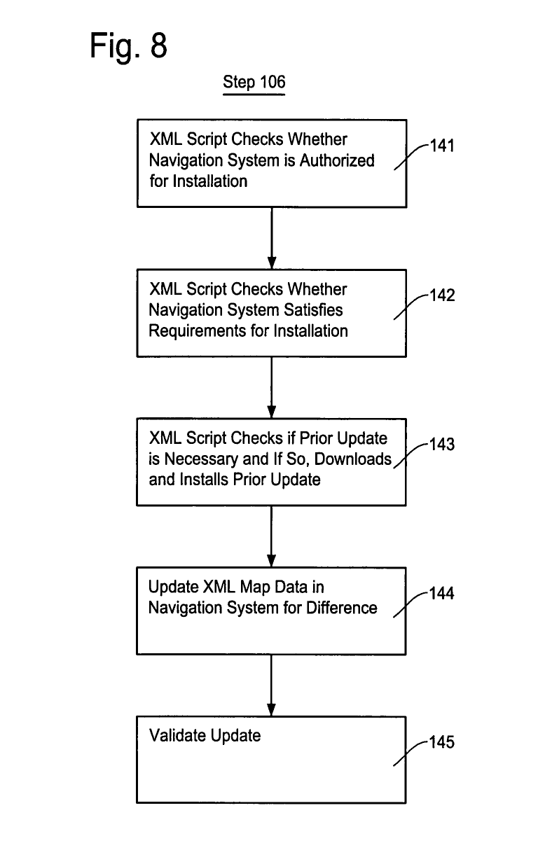

An example of procedure for executing the XML script to install the updated XML map data in the present invention is described with reference to the flow chart of FIG. 8. In other words, the process of FIG. 8 is a sub-process of the step 106 of the flow chart of FIG. 5. In step 141, as the navigation system 91 executes the procedure to update the XML map data, the XML script checks to determine if the navigation system 91 is authorized for the update. This authorization process may be used to check if the user of the navigation system has paid the download fee for the update. Further, the XML script may include an activation key unique to the updated XML map data and conducts the update procedure when a user key unique to the navigation system satisfies a predetermined relationship with the activation key. This process is effective in protecting the updated XML map date from illegal copying.

Then, in step 142, the XML script will check if the navigation system satisfies the requirements for carrying out the update procedure. For example, the space of memory required to update may also be checked to determine whether the storage device in the navigation system can store the updated map data. The XML script may also check whether the existing map data in the navigation system is in the XML format.

In step 143, the XML script will next check whether any prior update would be necessary. If the prior update is deemed necessary, the XML script will so notify the user. If the user wants, the XML script instructs the navigation system to download and install the perquisite map data. If all the requirements are met, the XML script will start to update the map data of the navigation system in step 144. Finally, the XML script will validate whether the update of the map data has been completed successfully in step 145.

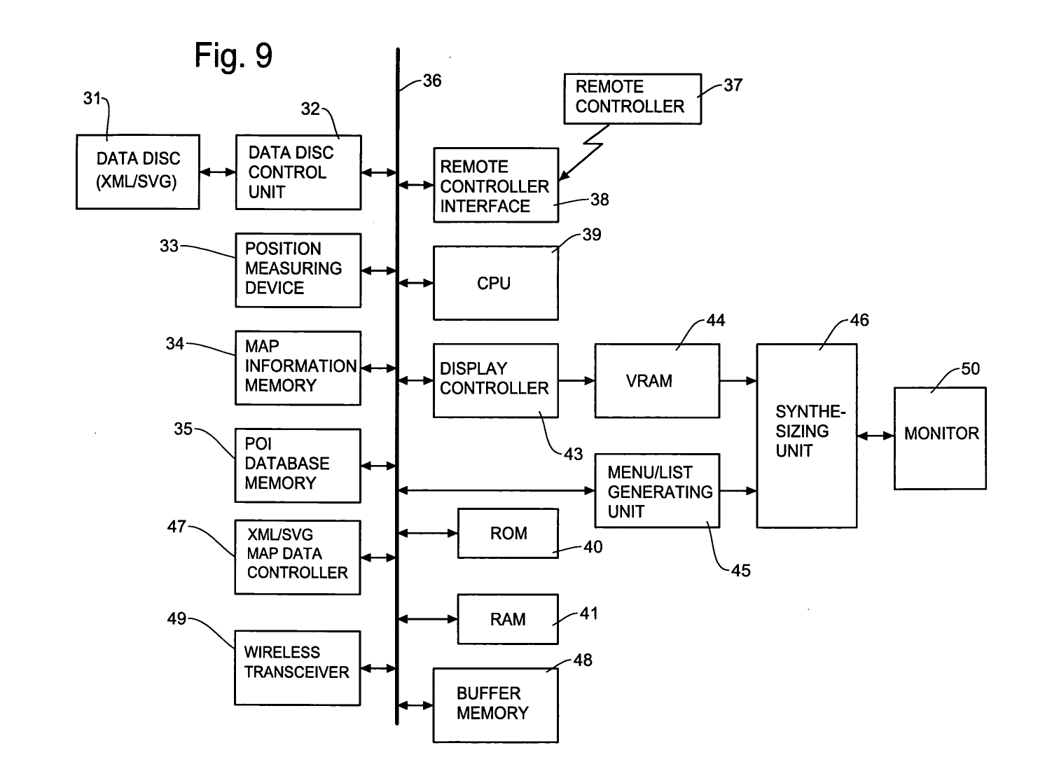

FIG. 9 shows a structure of a vehicle navigation system for implementing the present invention. While the vehicle navigation system is explained for an illustration purpose, the present invention can also be applied to other types of navigation system, such as a portable navigation device implemented by a PDA (personal digital assistant) device, other hand-held devices such as a wireless telephone, or a laptop or notebook computer.

In the block diagram, the navigation system includes a map storage medium 31 such as a hard disc, CD-ROM, DVD or other storage means (hereafter “data disc”) for storing the map data in the XML/SVG format. The navigation system includes a data disc control unit 32 for controlling an operation for reading the map information from the data disc, and a position measuring device 33 for measuring the present vehicle position or user position. For example, the position measuring device 33 has a vehicle speed sensor for detecting a moving distance, a gyroscope for detecting a moving direction, a microprocessor for calculating a position, a GPS (global positioning system) receiver, and etc.

The block diagram of FIG. 9 further includes a map information memory 34 for storing the map information which is read from the Data disc 31, a database memory 35 for storing database information such as point of interest (POI) information which is read out from the Data disc 31, a remote controller 37 for executing a menu selection operation, an enlarge/reduce operation, a destination input operation, etc. and a remote controller interface 38. Although a remote controller is a typical example for selecting menus, executing selected functions and etc., the navigation system includes various other input methods to achieve the same and similar operations done through the remote controller.

In FIG. 9, the navigation system further includes a bus 36 for interfacing the above units in the system, a processor (CPU) 39 for controlling an overall operation of the navigation system, a ROM 40 for storing various control programs such as a route search program and a map matching program necessary for navigation control, a RAM 41 for storing a processing result such as a guide route, a display controller 43 for generating map image (a map guide image and an arrow guide image) on the basis of the map information, a VRAM 44 for storing images generated by the display controller 43, a menu/list generating unit 45 for generating menu image/various list images, a synthesizing unit 46, a wireless transceiver 49 for wireless communication to retrieve the map data or other data from a remote server, a buffer memory 48 for temporally storing data for ease of data processing, and a monitor (display) 50.

An XML/SVG map data controller 47 controls the operation of the navigation system for utilizing the layered XML/SVG map data which is constructed on the basis of the administrative regions. In the conventional technology, as noted above, the map data of the selected area is divided into a plurality of cells (meshed portions). In the present invention, however, the XML/SVG format map data is constructed in a layered structure which is based on administrative regions such as states, counties, and cities. The XML/SVG map data controller 47 can be a separate processor or a part of CPU 39.

In the configuration described above, the map storage medium 31 is a rewritable medium into which the updated XML map data may be stored. As the XML script of the updated XML map data is executed by the CPU 39 (controller 47), the updated XML map data is saved in the map storage medium 31. The configuration of the navigation system under the present invention is not limited to the configuration described with reference to FIG. 9. The navigation system may store the basic map information in a DVD disc while the updated data may be stored on a separately provided memory device such as a hard disk. Both the DVD disk and the memory device work in tandem to provide up-to-date map information.

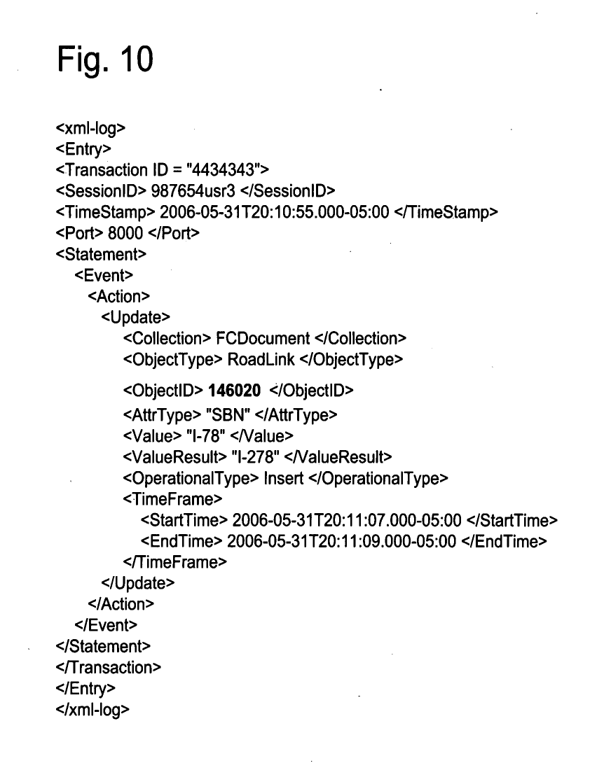

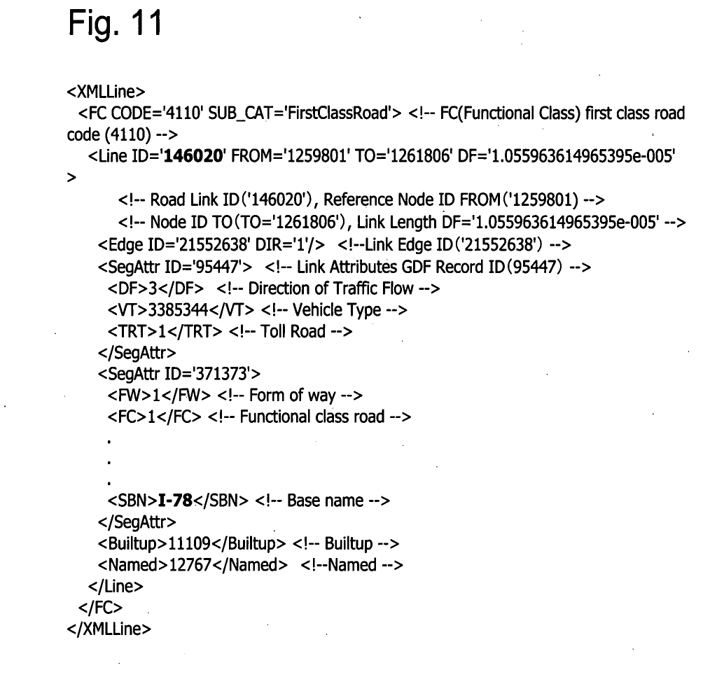

FIGS. 10-14 show examples of description in the XML format map data for updating the map data according to the present invention. These examples are directed to the case where the XML format map data is produced by the map data supplier rather than the map data delivery server. FIG. 10 is an example of description of a map log produced by the map data supplier when the map data is updated. FIG. 11 shows an example of structure of the XML format map data indicating a particular road link which is used in the navigation system and the map data delivery system of the present invention. As shown, the road link involved in the update is specified by a line ID which is denoted by bold characters in this example.

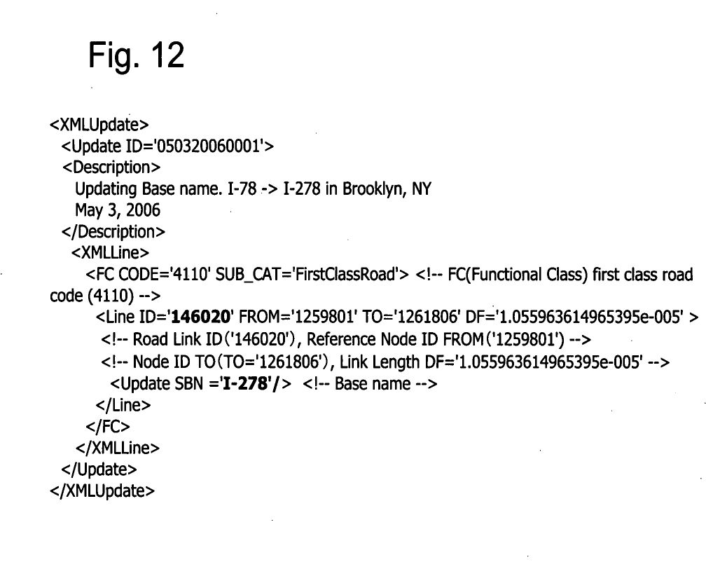

FIG. 12 shows an example of description of the XML format map data derived from the map log of FIG. 10 indicating the update related to the particular road link. The map data delivery server 53 of FIG. 4 analyzes the map log of FIG. 10 and produces the XML format data of FIG. 12 for updating the map data in the navigation system. This example shows the case to change the base name “I-78” of a road in New York to “I-278”. The first tag <XMLUpdate> indicates that this XML text is directed to the update operation. The particular road in this case is specified by the line ID “146020”.

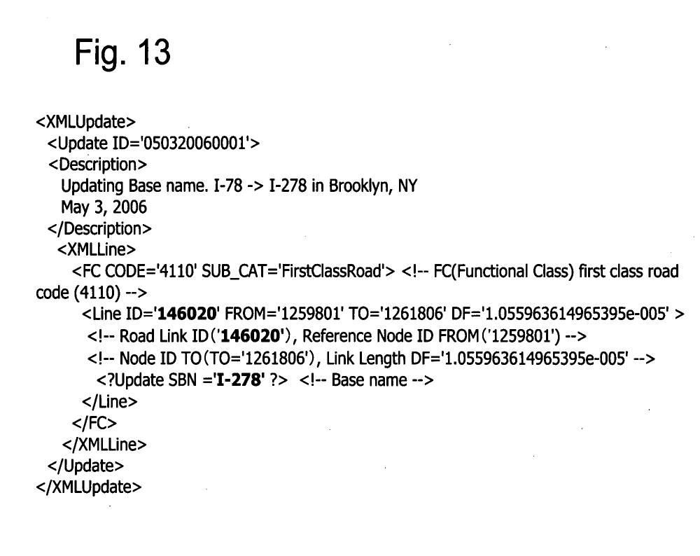

FIG. 13 shows an example of description of the XML format map data almost identical to that of FIG. 12 except that it is described in a manner to show the update operation of the navigation system. Namely, the navigation system analyzes the updated XML map data from the map data delivery server 53. As a result, the navigation system knows that an update operation must be conducted, an element to be updated is a road link specified by the line ID “146020”, and an attribute to be updated is a base name which is changed to “I-278”. Thus, the navigation system executes the update operation to change the name of the road to “I-278”.

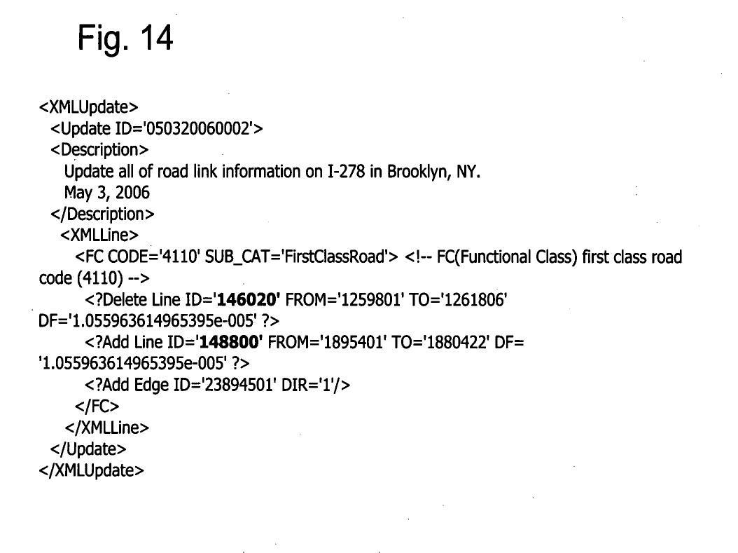

FIG. 14 shows another example of description of the XML format map data derived from a map log from the map data supplier indicating the update to replace a particular line with another line. In this example, a road specified by a line ID “146020” which extends from a location “1259802” to a location “1261806” is replaced with a road specified by a line ID “148800” which extends from a location “1895401” to a location “1880422”. For doing this, the navigation system deletes the data associated with the line ID “146020” and adds the data associated with the line ID “148800”.

As has been described above, according to the present invention, the map data delivery system is able to update the map data for a navigation system in realtime and deliver the updated map data to the user at any desired time. The map data is in the XML format so that the map data can be easily modified, combined with other map data, and transmitted through the communication network. Thus, the present invention allows frequent renewal of the map data for navigation systems with use of a simple configuration without requiring a high level processor or a long conversion time. Further, since each update data includes past update data, the complete data necessary for the update can be downloaded from the map data delivery server through one operation. Accordingly, it is unnecessary for the map data delivery server or manufacturer of the navigation system to prepare an enormous amount of combinations of the updated map data.

Although the invention is described herein with reference to the preferred embodiment, one skilled in the art will readily appreciate that various modifications and variations may be made without departing from the spirit and scope of the present invention. Such modifications and variations are considered to be within the purview and scope of the appended claims and their equivalents.

What is claimed is:

1. A realtime map data delivery system for delivering updated map data, comprising:
a map data supplier server which generates, in realtime, map data in a predetermined format every time when the map data is updated;
a map data delivery server which retrieves, in realtime, updated portions of map data and converts the updated map data to an extensible markup language format (updated XML map data) and stores the updated XML map data for delivery; and
a navigation system which stores XML format map data and accesses the map data delivery server through a communication network and downloads the updated XML map data to update the XML format map data.

2. A realtime map data delivery system as defined in claim 1, wherein the map data delivery server delivers an XML script attached to the updated XML map data to conduct an update procedure in the navigation system when the updated XML map data and the XML script are downloaded.

3. A realtime map data delivery system as defined in claim 1, wherein the map data delivery server delivers the updated XML map data as soon as the updated XML map data is created or after accumulating the updated XML map data for a predetermined time period.

4. A realtime map data delivery system as defined in claim 2, wherein the map data delivery server further delivers an update data ID and update information attached to the updated XML map data where the update data ID indicates an identity of the updated XML map data and the update information indicates an area name, road name, contents of update or other information associated with the updated XML map data.

5. A realtime map data delivery system as defined in claim 4, wherein the map data delivery server further delivers update information concerning prior update made during a predetermined past time period attached to the updated XML map data.

6. A realtime map data delivery system as defined in claim 4, wherein when accessing the map data delivery server, a user of the navigation system can see the update data ID and the update information (area name, road name, content of update, etc.) attached to the updated XML map data so that the user can make a decision whether the update is necessary.

7. A realtime map data delivery system as defined in claim 2, wherein the XML script includes an activation key unique to the updated XML map data and conducts the update procedure in the navigation system when a user key unique to the navigation system satisfies a predetermined relationship with the activation key.

8. A realtime map data delivery system as defined in claim 2, wherein when downloading the updated XML map data, the XML script checks whether the download procedure needs a previous update and downloads the prerequisite update when the prerequisite update has not been installed in the navigation system.

9. A realtime map data delivery system as defined in claim 2, wherein when downloading the updated XML map data, the XML script checks whether the download procedure needs a previous update and notifies the user when the prerequisite update has not been installed in the navigation system.

10. A realtime map data delivery system as defined in claim 1, wherein the updated XML map data is delivered to a computer of a user of the navigation system through internet and transferred to the navigation system through a storage medium or a via wireless transmission means.

11. A realtime map data delivery system as defined in claim 1, wherein the map data delivery server stores a user profile received from a user of the navigation system and delivers the updated XML map data reflecting preferred settings defined in the user profile.

12. A realtime map data delivery system as defined in claim 11, wherein the preferred settings defined in the user profile include an area selected by the user so that the map data delivery server delivers the updated XML map data concerning only to the selected area.

13. A method of delivering map data in realtime, comprising the following steps of:
generating map data in a predetermined format every time when the map data is updated;
retrieving updated portions of map data as soon as the updated map data is generated;
converting the updated map data in the predetermined format to an extensible markup language format (updated XML map data);
accumulating and storing the updated XML map data for a predetermined period of time; and
downloading the updated XML map data through a communication network and installing the updated XML map data in a navigation system.

14. A method of delivering map data in realtime as defined in claim 13, wherein the step of converting the map data to the updated XML map data includes a step of attaching an XML script to the updated XML map data to conduct an update procedure in the navigation system when the updated XML map data and XML script are downloaded.

15. A method of delivering map data in realtime as defined in claim 13, wherein the step of converting the map data to the updated XML map data includes a step of attaching an update data ID and update information to the updated XML map data where the update data ID indicates an identity of the updated XML map data and the update information indicates an area name, road name, contents of update or other information associated with the updated XML map data.

16. A method of delivering map data in realtime as defined in claim 15, further includes a step of attaching update information concerning prior update made in the past during a predetermined time period to the updated XML map data.

17. A method of delivering map data in realtime as defined in claim 15, wherein a user of the navigation system can see the update data ID and the update information (area name, road name, content of update, etc.) attached to the updated XML map data so that the user can make a decision whether the update is necessary.

18. A method of delivering map data in realtime as defined in claim 14, wherein the step of downloading the updated XML map data includes a step of checking whether the download procedure needs a previous update and a step of downloading the prerequisite previous update when the prerequisite previous update has not been installed in the navigation system.

19. A method of delivering map data in realtime as defined in claim 13, further comprising a step of storing a user profile received from a user of the navigation system and delivers the updated XML map data reflecting preferred settings defined in the user profile.

20. A method of delivering map data in realtime as defined in claim 13, wherein the preferred settings defined in the user profile include an area selected by the user so that the updated XML map data concerning only to the selected area is delivered to the user.
